(19) United States
(12) Patent Application Publication
(10) Pub. No.: US 2006/0232774 A1
(43) Pub. Date: Oct. 19, 2006

(54) Method for Generation of a Digital Output Signal of a Photosensor and Its Design

(76) Inventor: Joerg Kunze, Ahrensburg (DE)

Correspondence Address: HOWSON AND HOWSON, SUITE 210, 501 OFFICE CENTER DRIVE, FT WASHINGTON, PA, 19034, US

(21) Appl. No.: 11/279,585

(22) Filed: Apr. 13, 2006

(30) Foreign Application Priority Data
Apr. 14, 2005 (DE) 10 2005 017 158.3

(51) Int. Cl. G01N 21/00

(52) U.S. Cl. 356/338

(57) ABSTRACT

A method for generating a digital output signal of a photosensor with at least one light-sensitive pixel is provided. An electrical intensity signal is generated by incident light, this being evaluated after or during an adjustable exposure time to generate a digital output signal. The exposure time is divided into time intervals. A time signal dependent on the number of time intervals that have passed during the exposure time is generated, and the intensity signal is compared with at least one adjustable reference value. The time signal is acquired as soon as the intensity signal reaches or exceeds or falls short of the reference value. The acquired time signal is evaluated as a digital output signal of the pixel. A structure of a photosensor for execution of the above method is also provided.

### BACKGROUND OF THE INVENTION

The invention concerns a method for generation of a digital output signal of a photosensor with at least one light-sensitive pixel, wherein an electrical intensity signal is generated by incident light, this being evaluated after or during an adjustable exposure time to generate a digital output signal. The invention also concerns a structure for such a photosensor for execution of the method.

In known photosensors, the pixel charge is varied based on incident light. The pixels are often constructed so that charge is built up by the incident light and increases essentially linearly with the amount of incident light. At high intensity the charge rises more quickly, so that overexposure of the pixel must be feared at unduly long exposure times. At low intensity virtually no charge can be built up. The built-up charge is converted in a converter to a voltage or current, which therefore rises with increasing intensity.

It is also possible for the charge to be broken down by incident light. The voltage or current then drops during the exposure time. The voltage and/or current can, depending on the polarity, be positive or negative. It is essential that the charge and therefore voltage or current change be based on incident light. A digital output signal for subsequent image production or evaluation can be generated from the voltage or current.

CCD sensors are known that have a shift register that feeds the charge of several pixels in succession to a common converter, in which the individual charges are converted to voltage values. The voltage values are converted in a subsequent analog/digital converter to a digital signal, for example, a gray value. CMOS sensors are also known in which a separate converter is assigned to each pixel, through which the charge is converted to voltage values. A parallel operating read-out unit can be present, to which the analog/digital converter is connected.

Both sensors have comparable characteristics of voltage versus time or of the digital output value versus intensity. A linear range is to be recognized, to which a saturation region is connected at unduly high intensity. This means that, at a given exposure time and weak light intensity, the pixels produce only a very weak, scarcely evaluable signal. The image is underexposed. At unduly high intensity the pixels, on the other hand, are saturated and do not produce a useable signal, either. The image is then overexposed.

A requirement therefore exists to influence the characteristics of a pixel and therefore of a photosensor with several pixels. The characteristic corresponds to the curve of the output signal as a function of intensity. Depending on the requirements, different curves, for example, linear or dynamically-compressed dependences are desired.

### SUMMARY OF THE INVENTION

The task underlying the invention is to create a method of the type just outlined so that flexible use and especially flexible variation or adjustment of the characteristic of such a photosensor becomes possible. Another underlying task of the invention is to provide a compact photosensor for execution of the method according to the invention.

The task according to the invention is solved in that the exposure time is divided into time intervals and a time signal dependent on the number of time intervals that have passed during exposure is generated, in that the intensity signal is compared with at least one adjustable reference value and the time is acquired as soon as the intensity signal has reached or surpassed or fallen short of the reference value, and in that the acquired time signal is evaluated as the digital output signal of the pixel. The time interval in the form of time cycles or interval numbers counted up or down or of correspondingly discrete values of a correspondingly designed counter represents a digital signal that can be used directly as a gauge of intensity. It is therefore proposed as a simple embodiment of the invention that the time signal be the number of elapsed time intervals or the difference between the number of time intervals corresponding to the exposure time and the number of time intervals that have passed.

Another advantage is seen in the fact that only digital data are processed. A high data rate is therefore possible.

In principle, it is found that the earlier the reference value is reached in a pixel, the higher the light intensity with which it was exposed. Different characteristics of the pixel can be generated according to the choice of reference value. The intensity signal frequently corresponds to a voltage or current that is generated by the charge built up in the pixel. Accordingly, either a voltage or current reference value is used as the reference value. In the following comments, voltages are often involved without this being a restriction.

For example, it can be prescribed that the reference value be constant during the exposure time. If the intensity signal reaches the reference value within the exposure time, the intensity and therefore a gray value for the image can be determined. Difficulties exist for a case in which the reference value is not reached within the exposure time.

It can then be expedient to change the reference value as a function of the time or number of elapsed time intervals. According to the choice of time curve for the reference value, different characteristics of the pixel can be generated. Consequently, it is possible, for example, to vary the reference value so that even weak intensities are recorded. If the intensity signal increases with increasing time, it becomes advantageous, if the reference value drops at least at the end of the exposure time. Weak intensities are then also reliably recorded.

It is also appropriate for the exposure time to be divided into time intervals of equal size. As an alternative, the exposure time can also be divided into variable time intervals. This can be effected by a correspondingly designed digital counter. It is then possible for the comparison of the intensity signal with the reference value to occur at selectable time intervals. It can also be prescribed for the comparison of the intensity signal with the reference value to occur in each time interval. The flexibility of the method can be increased with these selection possibilities, especially with a view toward a time-dependent reference value.

By providing a time-variable reference value, for example, a reference voltage, different and easily manageable or evaluable characteristics of the pixel can already be generated. However, by choosing an appropriate time signal or an appropriate time curve of the time signal, the generated characteristic of the pixel can also be decidedly influenced.

It can be prescribed that the time signal be a digital time value assigned to the number of elapsed time intervals. This has the advantage that the acquired time signal is directly a digital signal that can be rapidly and easily processed in the subsequent image evaluation.

It can be appropriate for the time value to vary at least during one section of the exposure time. It can also or additionally be prescribed that the time value be constant for one section of the exposure time, independently of the number of time intervals. In a simple case it can thus be prescribed that the time value depend linearly on the number of elapsed time intervals at least during one section of the exposure time. A digital time value can correspond here to the number of elapsed time intervals or the difference between the number of time intervals corresponding to the total exposure time and the number of elapsed time intervals.

In principle, it is arbitrary how the time curves of the reference value or time value are called up as a function of the number of elapsed time intervals. It can be prescribed that a reference value in a memory unit be assigned to each time signal, each number of elapsed time intervals or each time interval or set of time intervals. The same applies for assignment of the time value to the number of elapsed time intervals. It is self-evident here that the number of time intervals can be counted either upward or downward as a function of time. Only the number of elapsed time intervals is discussed subsequently without restriction.

For example, a desired curve for the reference value or time value can initially be calculated and discrete reference values and/or time values entered in a memory or assignment table, which are then called up for the corresponding number of elapsed time intervals. For example, the same reference value can be entered in the memory for each time interval. The reference value would then be constant during the entire exposure time.

It is also possible to provide several memory units that are switchably connected to the comparison units or comparison unit and in which different curves of the reference values are stored that are adapted to special conditions, especially light conditions. The same applies for assignment of the number of elapsed time intervals to the time values. Consequently, for recordings with high light intensity in bright surroundings, the first reference value or reference value curve can be chosen. For recordings with only limited intensity in dark surroundings a different reference value or reference value curve can be chosen by simple switching of the memory units, which is called up by comparison units. The flexibility during generation of characteristics of a photosensor can therefore be significantly increased.

As described above, the reference value is available in digital form present in memory. However, it is also possible for the reference value to be an analog signal, for example, a constant voltage value that is supplied to the comparison unit. Time-dependent reference value curves can also be readily displayed in analog fashion by corresponding circuits.

The structure of a photosensor, with at least one light-sensitive pixel in which incident light generates an electrical intensity signal that is evaluated after or during an adjustable exposure time to generate a digital output signal, includes at least one pixel that is connected to a counter that divides the exposure time into time intervals and generates a time signal dependent on the number of time intervals that have passed during the exposure time, and a comparison unit that compares the intensity signal with at least one adjustable reference value, and also has an acquisition unit that acquires the time signal as soon as the intensity signal reaches, falls short of, or exceeds the reference value, the time signal being evaluable as the digital output signal of the pixel. This structure permits generation of a digital signal without an ordinary analog/digital converter. The time signal generated by the counter can be the number of time intervals or the difference between the number of time intervals corresponding to the exposure time and the number of elapsed time intervals. This signal can be easily evaluated digitally.

It can also be prescribed that the time signal be a digital time value and that the counter associate the number of elapsed time intervals with a digital time value. It is expedient here for the counter to have an assignment unit or to cooperate with an assignment unit in which the number of elapsed time intervals is associated with a digital time value. A time curve of the time signal can therefore be generated that deviates from the number of time intervals that often increases or diminishes linearly during the exposure time. The characteristic of the sensor can therefore be significantly influenced and varied.

The pixel therefore includes only a converter and an acquisition unit for acquiring the current time signal upon reaching the reference value. These elements are small in construction. It is therefore readily possible for the photosensor to be structured linearly with a number of pixels in a row. A line scan camera is equipped with it in the usual manner.

The photosensor can also be constructed flat, with a number of pixels that are arranged in matrix form in lines and columns. A matrix camera can be equipped with it in the usual manner.

The reference value to be assigned to a time interval is preferably called up by the comparison unit from an external memory unit. It can be prescribed here that a memory unit external to the pixel be present, in which a stipulated reference value can be stored for each signal, time value or time interval or for each set of time values or time intervals, which is connected to the comparison unit. The space requirements for integration of a pixel according to the invention on a sensor can therefore be reduced. For example, it is possible to assign the same reference value to each time interval in order to have a reference value that is constant over the entire exposure time.

The counter for generation of the time signal is also arranged external to the pixel or pixels in a photosensor on-chip, or outside of the sensor off-chip, and is connected to the acquisition unit or the acquisition units. The space requirement can therefore also be further reduced.

In several pixels, especially in their arrangement in a line-like photosensor, it is expedient for a common counter and/or common reference value memory to be assigned to each pixel connected to the acquisition unit or to the comparison unit for each pixel. In the arrangement in a matrix photosensor, a common counter and/or common reference value memory can be assigned to each pixel of a column and/or line and connected to the acquisition unit or the comparison unit of each pixel of a column and/or line.

In principle, it would be possible to assign a reference value memory unit or memory place or counter to each pixel. The structure of the photosensor, however, would be more complex on this account. The pixels of the photosensor would also not all have the same characteristics, whereby problems might develop in image data evaluation. This structure can likewise be expedient for many applications.

### BRIEF DESCRIPTION OF THE DRAWINGS

The invention is further explained below by means of the schematic drawings. In the drawings:

FIG. 1 illustrates a block diagram of an arrangement according to the invention,

FIG. 2 illustrates a block diagram of a line-like photosensor,

FIG. 3 illustrates a block diagram of a planar photosensor,

FIG. 4 illustrates the qualitative sensor characteristic at a constant voltage reference value,

FIGS. 5-7 each illustrates the qualitative sensor characteristic at a voltage reference value and/or time value that varies over the exposure time,

FIGS. 8a and 8b each illustrates a block diagram of a CCD and CMOS sensor according to the prior art, and

FIG. 9 illustrates the qualitative sensor characteristic in the sensors according to the FIGS. 8a, 8b.

### DETAILED DESCRIPTION OF THE INVENTION

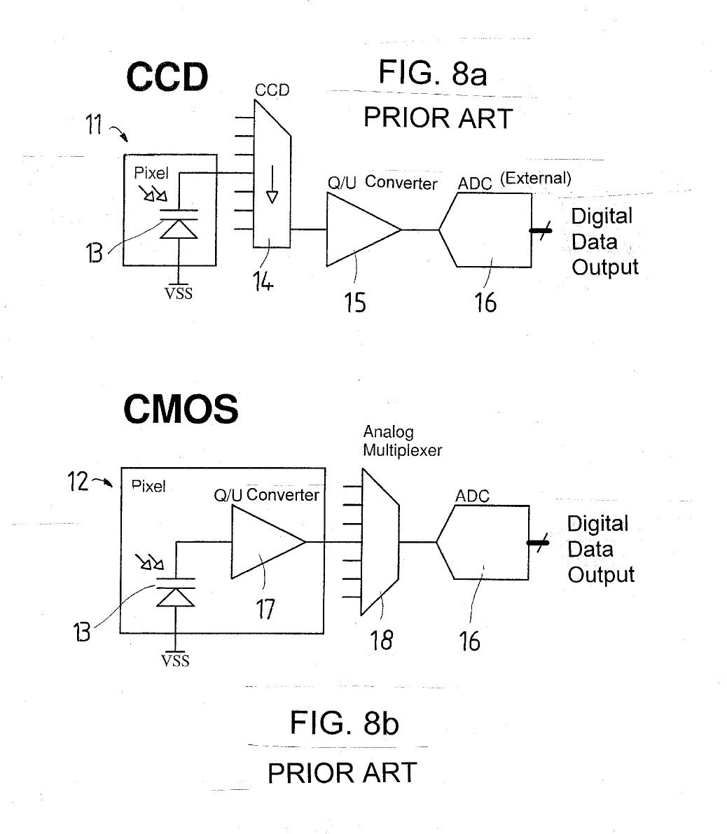

In FIG. 8 of the drawings, a CCD sensor 11 and a CMOS sensor 12 are shown one beneath the other. Both sensors have a pixel with a light-sensitive cell 13 in which incident light is converted to a charge.

In the CCD sensor, the charge Q of each pixel 11 after an exposure time T is fed to a common converter 15 by a shift register 14, in which the charge is converted to a voltage U. The voltage value is converted to a digital signal in a connected analog-digital converter 16. In contrast to the CCD sensor, each pixel 12 has its own converter 17 in a CMOS sensor. The voltage values generated in it can be read out by a multiplexer 18 and fed to the analog/digital converter 16.

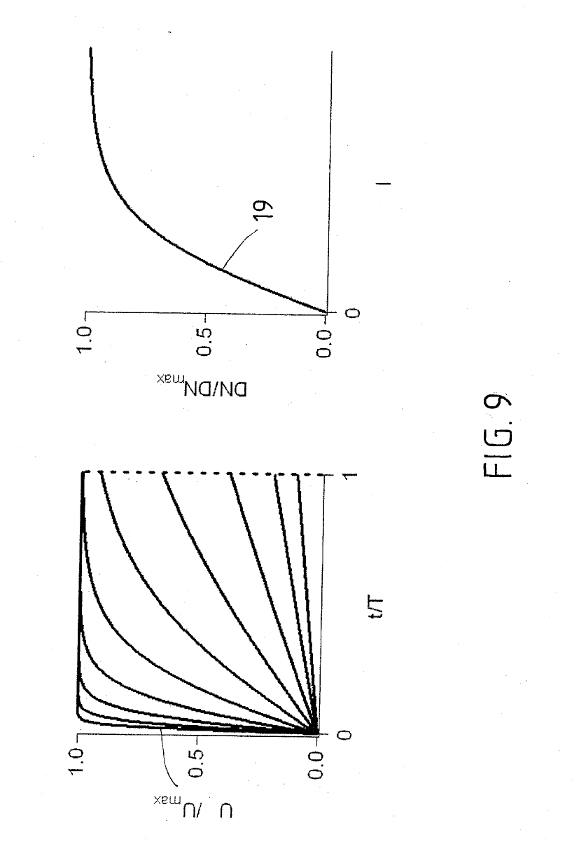

Both sensors have roughly the same characteristic that is shown in FIG. 9. The voltage curve of U over the time until the saturation voltage Uₘₐₓ of such a sensor is reached can be approximated by a roughly tan h-like function. The voltage rises until it reaches the saturation voltage. If the saturation voltage is reached within the exposure time, the pixel and therefore the image is overexposed there. The curve of the digital output signal DN versus intensity with an initially linear region 19 (shown on the right in FIG. 9) is obtained. In the interest of clarity, the ratio of DN/DNₘₐₓ and U/Uₘₐₓ is plotted versus time ratio t/T in the diagrams. Values are therefore obtained between 0 and 1.

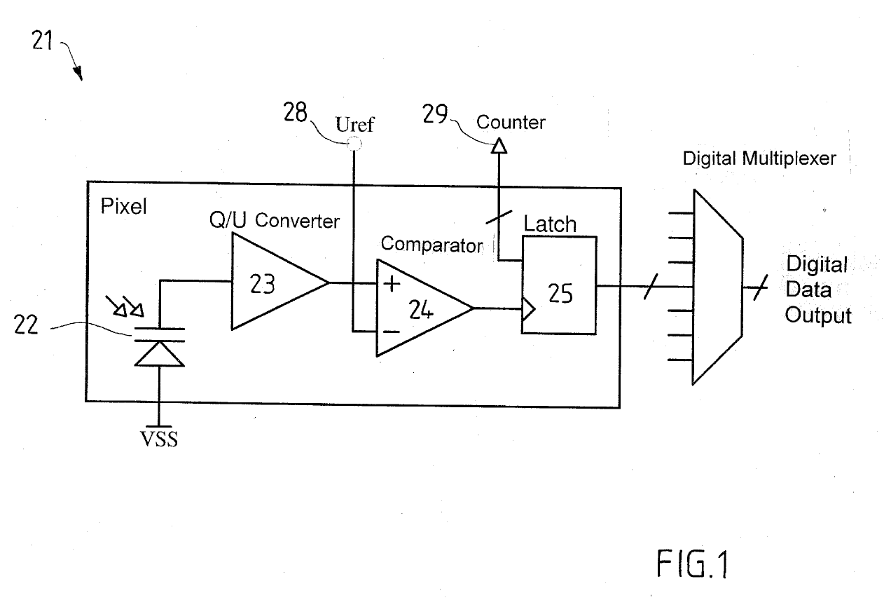

In the design of the pixel 21 shown in FIG. 1, a converter 23 is assigned to each light-sensitive cell 22 in a fashion similar to the ordinary CMOS sensor; this converts the charge to a voltage continuously. The output of the converter 23 is connected to a comparison unit 24 which compares the voltage value, increasing during continuous illumination, to a voltage reference value U_{ref}. The comparison unit 24 is connected for this purpose to a reference value sender 28 (not shown) for the voltage reference value.

A counter 29 (not further shown) is also present that is connected to the acquisition unit 25 or pixel 21. The counter divides the assignable and adjustable exposure time T into time intervals and generates a time signal. The time signal directly includes the number of time intervals that have passed during exposure, or an assigned digital time value DN that also depends on time, which is fed to the acquisition unit. If the voltage value from the converter 23 exceeds the voltage reference value, the acquisition unit 25 is made to record the actual time signal from a corresponding signal of the comparison unit 24, i.e., the number of elapsed time intervals or the time value DN of the counter.

After the exposure time or immediately after storage, this acquired time value is read out by a read-out unit 26. Since the time value DN is already the digital signal, this can already be used as a digital output signal of the sensor. An ordinary analog/digital converter, as in a CCD sensor or CMOS sensor, is not necessary.

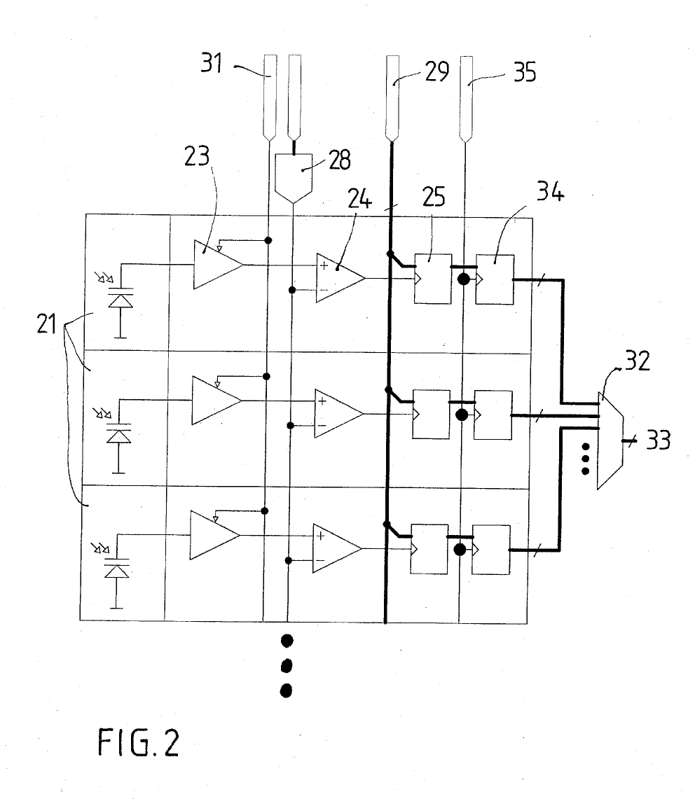

A linear arrangement of several pixels 21 is shown in FIG. 2, which therefore form a linear photosensor for a line scan camera. The voltage reference value is fed to each comparison unit 24 of each pixel by a voltage reference value sender 28 external to the sensor. The counter 29 is also arranged external to the pixels on-chip or off-chip, and delivers the time signal to each acquisition unit. A compact design of the linear photosensor can therefore be achieved.

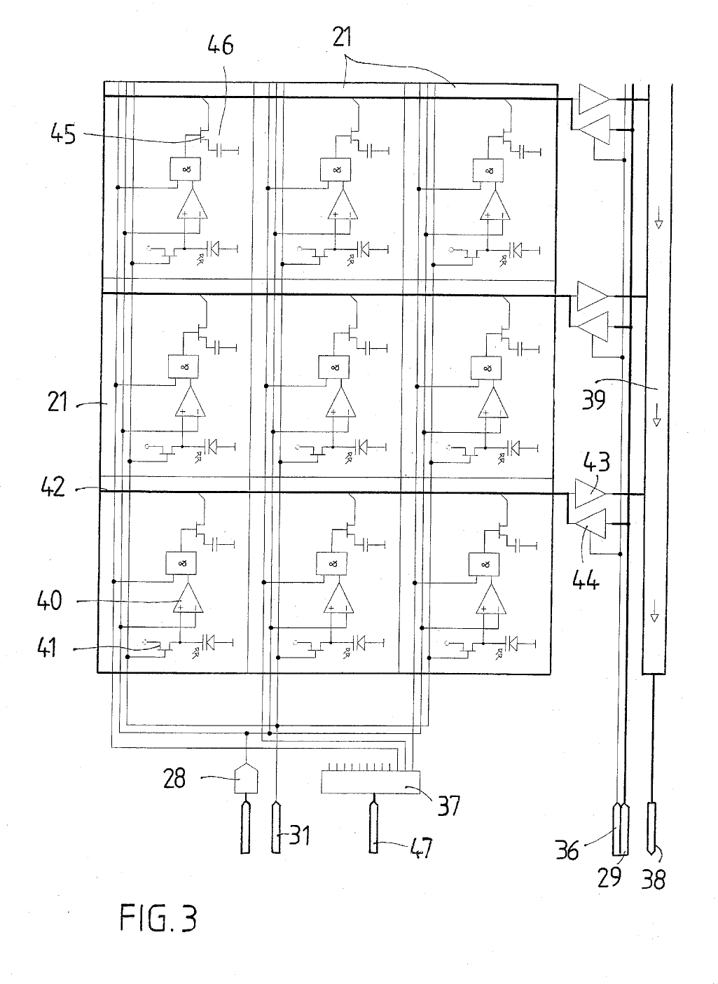

FIG. 3 shows a possible arrangement of several pixels 21 in lines and columns to form a matrix-like photosensor for a matrix camera. Here again, a common external reference value generator 28 for each comparison unit 24 and a common external counter 29 for each acquisition unit 25 of each pixel are present.

During exposure, an increasing voltage is generated in each converter according to the curve in FIG. 9. If the voltage value fed to the comparison unit reaches or exceeds the voltage reference value, the time signal is acquired and stored or immediately output. The charge is collected until the voltage reference value is reached. By appropriate choice of the voltage reference value, exposures with weak intensity can therefore also occur. Overexposure can also generally be avoided.

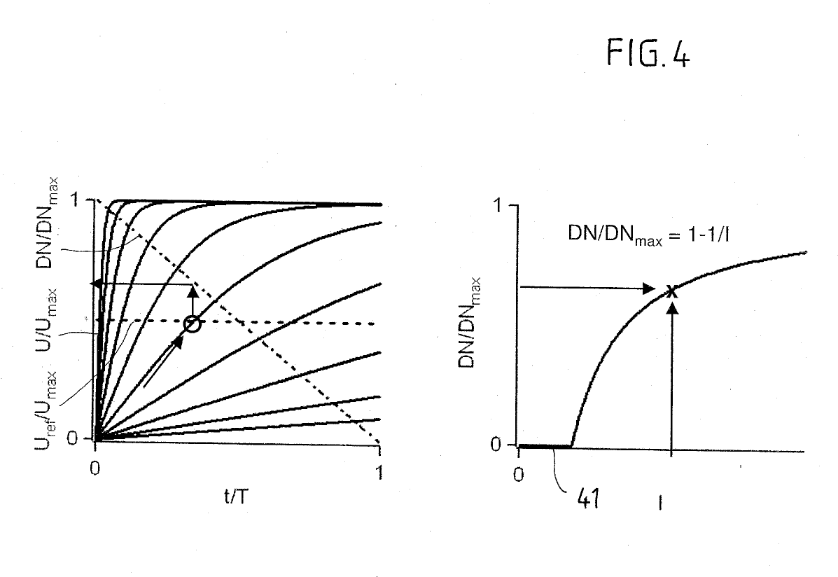

The characteristic of the sensor and the curve of its digital output signal versus intensity depend on both choice of the voltage reference value and its time curve and on the choice of the time curve of the time value. In the following examples the digital output signal corresponds to the digital time value DN generated by the counter. In the following FIGS. 4-7, different characteristics are shown which are generated by different time curves of the voltage reference value U_{ref} and/or the time value DN. The ratios to the maximum values are always shown in the diagrams so that, except for the intensity values, a value range from 0 to 1 is always obtained.

In all the following diagrams and the subsequent formulas, a tan h-like saturation behavior of the generated voltage over the exposure time is assumed and shown. Other approximation functions for the voltage curve are naturally usable, wherein the time dependences must be adjusted and varied according to these approximation functions. In addition, in the interest of clarity, only the qualitative characteristic, without considering technical units and the like, is calculated or shown by the mathematical formulas and in the diagrams. During calculation and determination of the quantitative characteristic, additional constants and parameters, for example, the actual exposure time, must be considered which depend, among other things, on the sensor employed. These, however, are measures known to those skilled in the art, and require no further explanation here.

FIG. 4 shows the characteristic of a pixel at a constant voltage reference value U_{ref}/Uₘₐₓ over the exposure time t/T. On the left in FIG. 4, the time curve of the generated voltage U/Uₘₐₓ and the digital time value DN/DNₘₐₓ generated from the time intervals are also shown, which are plotted versus time t/T. Here, the time value DN corresponds to the number of time intervals, counted from the maximum time value DNₘₐₓ to time value 0. On the right in FIG. 4, the curve of the digital time value DN/DNₘₐₓ is plotted versus intensity I. The following relations apply approximately:
U_{ref}(t)=constant
DN(t)=DNₘₐₓ(1−t/T)
DN/DNₘₐₓ(I)=1−1/I

An initial curve region 41 of lowest intensity is apparent in which the voltage value being compared does not reached the voltage reference value within the exposure time. The pixel was then underexposed. In the subsequent curve region, the digital output value DN converges roughly according to the function 1 −1/I to value DNₘₐₓ.

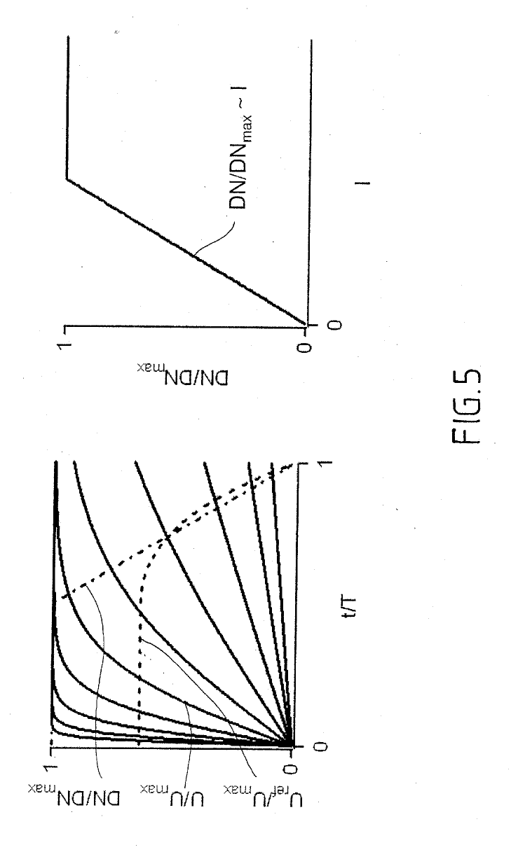

However, the voltage reference value and the time curve of the time value DN can be varied. In FIG. 5 a possible characteristic with a varying voltage reference U_{ref}/Uₘₐₓ and a varying time value DN/DNₘₐₓ is shown versus exposure time t/T. The relations DN(t) and U_{ref}(t) are shown in the following equations:
For t/T<½:
U_{ref}(t)=Uₘₐₓ·tan h(c/4)
DN(t)=DNₘₐₓ
For t/T≧½:
U_{ref}(t)=Uₘₐₓ·tan h[c·t/T·(1−t/T)]
DN(t)=DNₘₐₓ·2·(1−t/T)
(with c as a selectable constant).

A linear curve of DN/DNₘₐₓ versus intensity is obtained to the end of the exposure time, as shown in the graph on the right in FIG. 5.

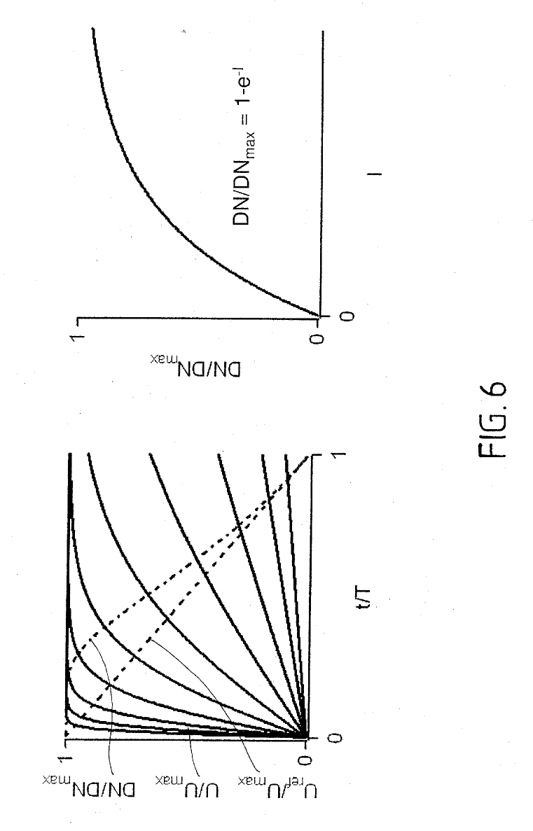

FIG. 6 shows the curves of DN/DNₘₐₓ(t) and U_{ref}/Uₘₐₓ(t) as a function of time t/T, which lead to an exponential curve roughly in the form 1−e^{-I} of the output signal DN/DNₘₐₓ versus intensity. With the assumed tan h-like voltage curve, this can be achieved on the following assignments:
U_{ref}(t)=Uₘₐₓ·(1−t/T)
DN(t)=DNₘₐₓ(1−e^{(-T/t a tan h(1-t/T))}

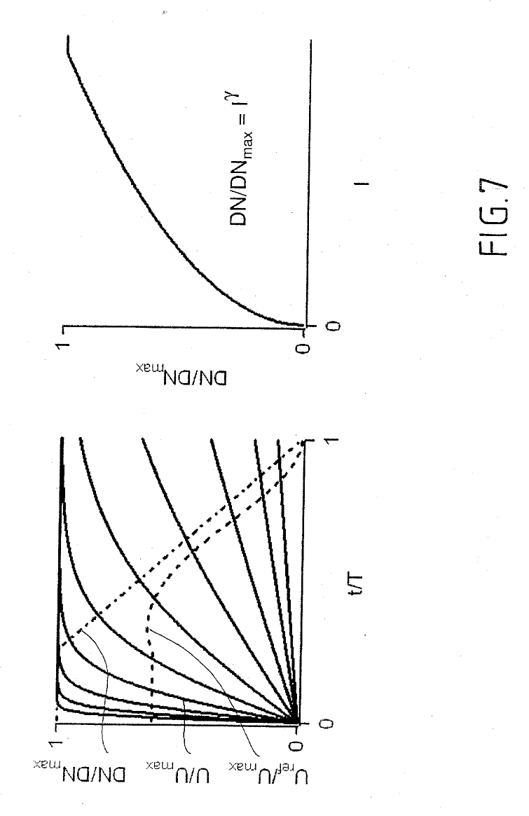

FIG. 7 shows the relations for DN/DNₘₐₓ(t) and U_{ref}/Uₘₐₓ(t) over time t/T, which are required in order to consider a γ-correction. This can be represented by the following equations:
For t/T<x₀:
U_{ref}(t)=Uₘₐₓ·tan h(c·x₀·(1−x₀)^{γ})
DN(t)=DNₘₐₓ
For t/T≧x₀:
U_{ref}(t)=Uₘₐₓ·tan h[c·t/T·(1−t/T)^{γ}]
DN(t)=DNₘₐₓ·(1−x₀)·(1−t/T)
(with γ and x₀ as selectable parameters and c as a selectable constant).

The characteristic DN/DNₘₐₓ=I^{1/γ} is approximately obtained.

The different curves of the voltage reference value, on the one hand, and/or of the time value, on the other hand, as a function of time can be easily generated by corresponding design of the reference value sender or counter. The reference value sender can include a memory in which a voltage reference value is assigned to each time interval. The counter can include an assignment unit in which the time value is assigned to each time interval or as a function of time. The desired and/or determined curves can therefore be represented discretely by addressable values.

The counter in the aforementioned embodiments already generates the digital time value as a function of time or number of elapsed time intervals. However, it is also possible for only the number of elapsed time intervals to be recorded and used as an output signal. In a subsequent assignment unit, the recorded number of time intervals can then be assigned to a time value, and the characteristic of the sensor generated.

1. A method for generation of a digital output signal of a photosensor having at least one light-sensitive pixel, comprising the steps of generating an electrical intensity signal by exposing the pixel to incident light and evaluating the intensity signal after or during an adjustable exposure time (T) to generate the digital output signal, said steps including:
dividing the exposure time (T) into time intervals;
generating a time signal dependent on a number of time intervals that have passed during the exposure time (T);
comparing the intensity signal with at least one adjustable reference value (U_{ref});
acquiring the time signal as soon as the intensity signal reaches or exceeds or falls short of the reference value; and
evaluating the recorded time signal as the digital output signal of the pixel.

2. A method according to claim 1, wherein the time signal is the number of time intervals, or a difference between the number of time intervals corresponding to the exposure time (T) and the number of time intervals that have passed.

3. A method according to claim 1, wherein the reference value (U_{ref}) is constant during the exposure time (T).

4. A method according to claim 1, wherein the reference value (U_{ref}) is varied as a function of time (t) or the number of elapsed time intervals.

5. A method according to claim 1, wherein the exposure time (T) is divided into time intervals of equal size.

6. A method according to claim 1, wherein the exposure time (T) is divided into variable time intervals.

7. A method according to claim 1, wherein the time signal is a digital time value (DN) assigned to the number of elapsed time intervals.

8. A method according to claim 7, wherein the digital time value (DN) varies at least during one section of the exposure time (T).

9. A method according to claim 8, wherein the digital time value (DN) depends linearly on the number of elapsed time intervals at least during one section of the exposure time (T).

10. A method according to claim 7, wherein the digital time value (DN) is constant independently of the number of time intervals for one section of the exposure time (T).

11. A method according to claim 7, wherein the digital time value (DN) corresponds to the number of time intervals, or the difference between the number of time intervals corresponding to the exposure time and the number of elapsed time intervals.

12. A method according to claim 1, wherein a comparison of the intensity signal with the reference value (U_{ref}) in selectable time intervals occurs.

13. A method according to claim 1, wherein a comparison of the intensity signal to the reference value (U_{ref}) occurs in each time interval.

14. A method according to claim 1, wherein in a memory unit a reference value (U_{ref}) is assigned to each time interval.

15. A method according to claim 1, wherein the intensity signal is a voltage generated in the pixel and the reference value (U_{ref}) is a voltage reference value.

16. A photosensor having at least one light-sensitive pixel (21) in which an electrical intensity signal is generated by incident light and evaluated after or during an adjustable exposure time (T) to generate a digital output signal, said pixel comprising:
a counter (29) that divides the exposure time (T) into time intervals and generates a time signal dependent on the number of time intervals that have passed during the exposure time (T);
a comparison unit (24) that compares the intensity signal with at least one adjustable reference value; and
an acquisition unit (25) that acquires the time signal as soon as the intensity signal reaches, falls short of, or exceeds the reference value;
wherein the time signal is evaluated as the digital output signal of the pixel.

17. A photosensor according to claim 16, wherein the time signal is the number of time intervals or the difference between the number of time intervals corresponding to the exposure time (T) and the number of elapsed time intervals.

18. A photosensor according to claim 16, wherein the time signal is a digital time value and the counter associates the number of elapsed time intervals with the digital time value.

19. A photosensor according to claim 18, wherein the counter has an assignment unit or cooperates with an assignment unit in which the number of elapsed time intervals is associated with the digital time value.

20. A photosensor according to claim 16, further comprising a memory unit (28) that is connected to the comparison unit (24) and that is external to the pixel in which the reference value that can be stipulated for each number of elapsed time intervals or its time value can be stored.

21. A photosensor according to claim 16, wherein the photosensor is designed linearly, with a number of pixels (21) in a row.

22. A photosensor according to claim 21, wherein the counter (29) and/or a reference value memory (28) is associated with each pixel and is connected to the acquisition unit (25) or the comparison unit (24) of each pixel.

23. A photosensor according to claim 16, wherein the photosensor is constructed flat with a number of pixels (21) that are arranged in a matrix of lines and columns.

24. A photosensor according to claim 23, wherein the counter (29) and/or a reference value memory (28) is associated with each pixel of a column and/or line and is connected to the acquisition unit (25) or comparison unit (24) of each pixel of a column and/or line.
